(19) United States
(12) Patent Application Publication
(10) Pub. No.: US 2006/0119056 A1
(43) Pub. Date: Jun. 8, 2006

(54) Transformable structure

(76) Inventor: Jens Christian Hoeybye Olsen, Broenshoej (DK)

Correspondence Address: WINSTON & STRAWN LLP, 1700 K STREET, N.W., WASHINGTON, DC, 20006, US

(21) Appl. No.: 11/314,742

(22) Filed: Dec. 20, 2005

Related U.S. Application Data
(63) Continuation of application No. PCT/DK04/00471, filed on Jul. 2, 2004.

(30) Foreign Application Priority Data
Jul. 2, 2003 (DK) PA 2003 01007

(51) Int. Cl. B62B 7/12

(52) U.S. Cl. 280/30

(57) ABSTRACT

A structure having a number of components adapted for in a first mode to be assembled in such a way that any one of at least two different supporting structures can be formed. In a second mode the structure is assembled in such a way that a storage structure can be formed. The structure includes a base having two halves each with a panel bridging a frame. The two base halves are connectable with each other in at least a first position where the panels are mainly flush and in at least a second position where the free edges of the frames are adjacent to each other. The structure further comprises at least two sets of elongated members adapted for in the first mode being assembled with the base in its first position and in the second mode being assembled with the base in its second position. The invention thereby provides a structure which is easy to transport and can be transformed into any one of the least two different supporting structures with little effort. Furthermore the structure provides a sturdy and solid construction.

### CROSS-REFERENCE TO RELATED APPLICATIONS

This application is a continuation of International application PCT/DK2004/000471 filed Jul. 2, 2004, the entire content of which is expressly incorporated herein by reference thereto.

### BACKGROUND ART

The present invention relates to a structure having a number of components adapted for in a first mode to be assembled in such a way that any one of at least two different supporting structures can be formed and in a second mode to be assembled in such a way that a storage structure can be formed.

Many different kinds of structures that are changeable from a supporting structure to a storage structure are known. Such structures can for example be folding chairs and folding tables which can be folded for easy storage.

As an example, British patent application GB 2375293 can be mentioned wherein a foldable table is disclosed. This can be easily folded for easy storage.

However it is often the case that even though the structures can be folded, they are not easy to transport. This is especially true if a car or the like is unavailable and the structures have to be transported by foot or by bicycle, as is the case in many larger cities.

U.S. Pat. No. 5,957,482 discloses a wagon, which can be folded to an easy-to-store structure. Although the wagon is easy to transport in urban areas and is foldable so that it takes little room when stored, it is not adapted to be converted into any other supporting structure, such as e.g. a table. Thus, the present invention seeks to overcome the deficiencies of the prior art.

### SUMMARY OF THE INVENTION

In one aspect of the invention, a structure is provided that can be transformed into a storage structure and that is easy to transport. This structure with little effort can be transformed into any one of at least two different supporting structures, each having a sturdy and solid construction. Also, the components of the transformable structure have a low production cost.

The structure according to the invention is formed with a base consisting of two halves, each comprising a panel bridging a frame, whereby the two base halves are connectable with each other in at least a first position where the panels are mainly flush and in at least a second position where the free edges of the frames are adjacent to each other, and at least two sets of elongated members adapted for in the first mode being assembled with the base in its first position and in the second mode being assembled with the base in its second position.

Thereby a structure is obtained that can easily be transformed from one of the at least two different supporting structures into another one and can moreover also be transformed into a storage structure.

In an advantageous embodiment the two base halves can be pivotally connected to each other about a hinge between the first position and the second position and the hinge can be mounted on a side wall of each frame, whereby the base is folded into a suitcase for easily storing the components in such a way that they are easy to transport.

For being able to build the different supporting structures the first set of elongated members can be mounted mainly perpendicular to the base, and the second set of elongated members can be adapted for crosswise and/or in extension to be connected with the first set of elongated members.

Furthermore a set of third elongated members adapted for crosswise and/or in extension to be connected with the first set of elongated members and/or crosswise and/or in extension to be connected with the second set of elongated members can be provided to the supporting structure adding to the various types of support structures possible to form.

In a preferred embodiment the peripheral edge zone of the panel can extend beyond the periphery of the frame whereby at least some of the components of the structure advantageously can be mounted within the limitation of the panel in at least some of the different support structures which the structure can occupy, whereby incisions in the panel can be shaped to allow elongated members attached to the frame to pass the panel.

In addition to the components already mentioned, more components can be added resulting in an even larger number of support structures. Such components could by way of example be wheels for mounting on the frame opposite the panel whereby a wagon can be built.

Other components could form a handle adapted for mounting on at least one of the frame halves whereby the wagon mentioned above could be pulled or the structure could in its storage structure be carried as a suitcase.

In an even further embodiment a piece of cloth can be extended between the sets of elongated members, providing a windshield or functioning as a supporting surface.

To ensure that the components are not loosely arranged in the storage structure with the risk of losing or destroying them there can on the inside the frame be provided a form molded to fit the components.

### BRIEF DESCRIPTION OF THE DRAWINGS

The invention will be explained in greater details below where further advantageous properties and example embodiments are described with reference to the drawings, in which

FIG. 1 shows, in perspective, a number of typical components for assembling a structure according to the invention,

FIG. 2 shows another support structure according to the invention,

FIG. 3 shows a third support structure according to the invention,

FIG. 4 shows a storage structure according to the invention,

FIG. 5 shows the storage structure from FIG. 4 in an open position,

FIG. 6 shows a fourth support structure according to the invention,

FIG. 7 shows a fifth support structure according to the invention, and

FIG. 8 shows a second storage structure according to the invention.

### DETAILED DESCRIPTION OF THE PREFERRED EMBODIMENTS

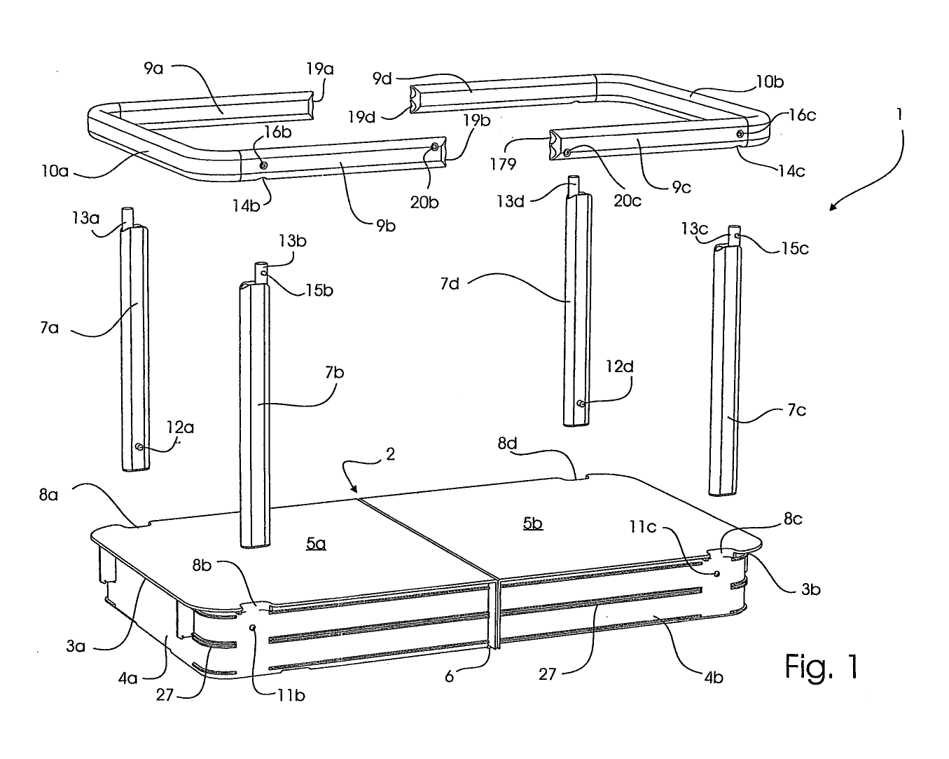

FIG. 1 shows, in perspective, typical components of a structure 1 according to the invention. The structure consists of a base 2 divided into two halves 3a,3b each consisting of a frame 4a,4b bridging a panel 5a,5b. The two bases are connected by a hinge 6 mounted on the edge of the frames opposite the panel.

A first set of elongated members 7a,7b,7c,7d can be mounted in channels 8a,8b,8c,8d provided on the frame halves perpendicular to the base 2. A second set of elongated members 9a,9b,9c,9d can be mounted crosswise to the first set of elongated members and a third set of elongated members 10a,10b can be mounted in extension of the second elongated members.

In order to mount the elongated members in the channels, a locking mechanism is provided consisting of a first set of engagement holes 11a,11b,11c,11d (only some of which are visible in the figure) provided on the base halves 3a,3b and threaded shafts 12a,12b,12c,12d (only some of which are visible in the figure) provided on the first set of elongated members. The threaded shaft is inserted through the first set of engagement holes and fixed by means of a nut (not shown).

However the first elongated members 7a,7b,7c,7d could be mounted to the base halves 3a,3b by a spring connection (not shown). This makes it possible to pull the first elongated member out from the frame 4a,4b thereby tensioning a spring (not shown) provided on the inside of the frame, rotating it to the desired position and releasing it whereby it will snap back alongside the frame as the spring extends.

The first elongated members 7a,7b,7c,7d are connected to the second elongated members 9a,9b,9c,9d by inserting the protrusions 13a,13b,13c,13d through a first set of insertion holes 14a,14b,14c,14d (only some of which are visible in the figure) whereby a second set of flexible splits 15a,15b,15c,15d (only some of which are visible in the figure) engages with a second set of engagement holes 16a,16b,16c,16d (only some of which are visible in the figure).

The components shown in FIG. 1 can be assembled to any one of the different supporting structures. The different structures all have a sturdy construction since the sets of elongated members interlock and therefore stabilize each other.

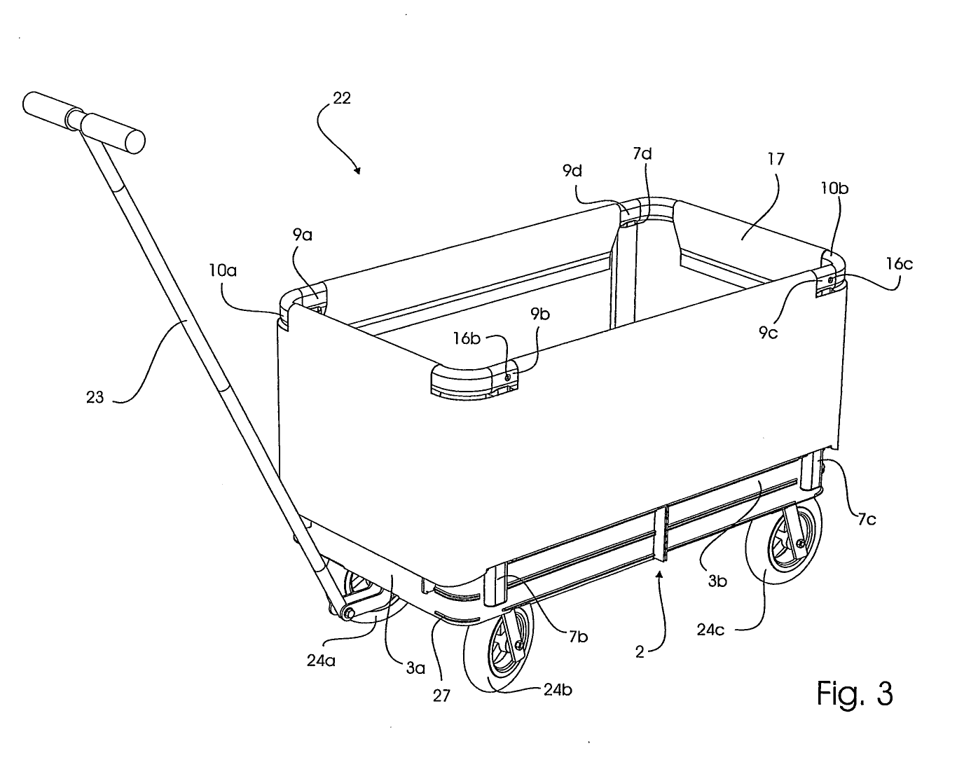

When assembled the structure 1 can have a piece of cloth 17 (as shown in FIG. 3) extending between the elongated members. This makes the structure suitable for many different applications, an example of which is a baby crib.

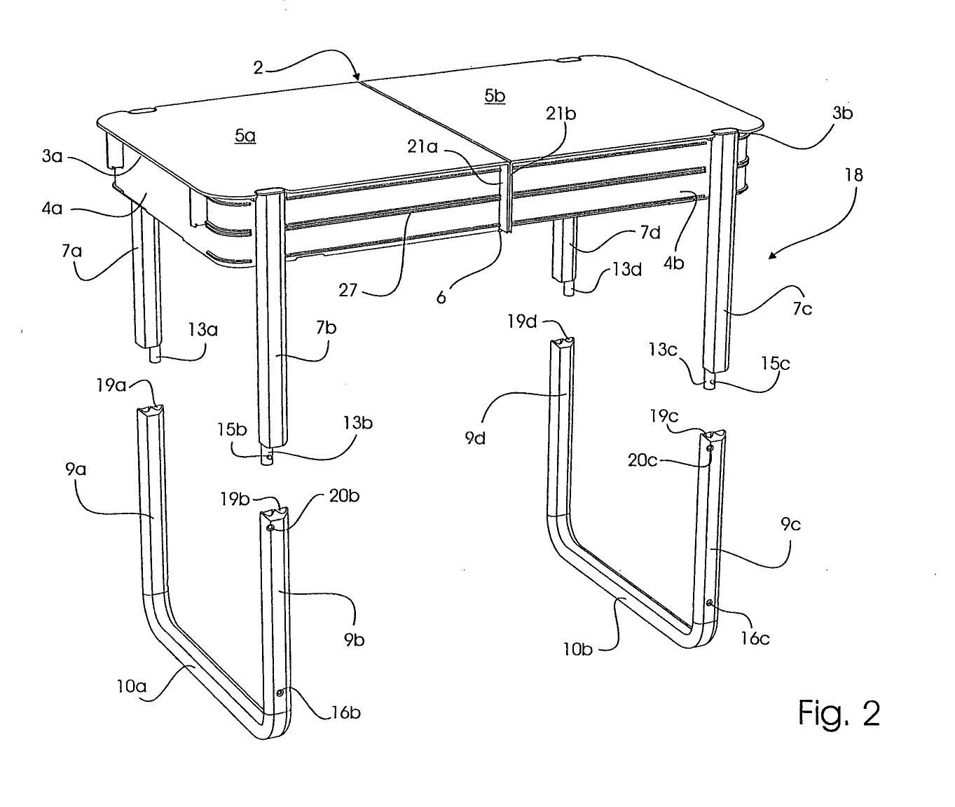

FIG. 2 shows a table 18 built with the components of the structure 1 shown in FIG. 1.

In this embodiment the first set of elongated members 7a,7b,7c,7d is mounted perpendicular to the panel 5a,5b extending outwards from the same side of the panel 5a,5b as the frame 4a,4b of each base half 3a,3b.

On the second set of elongated members 9a,9b,9c,9d, a second set of insertion holes 19a,19b,19c,19d and a third set of engagement holes 20a,20b,20c,20d are provided in order to mount the second set of elongated members 9a,9b,9c,9d in extension of the first set of elongated members 7a,7b,7c,7d. This is carried out by inserting the protrusions 13a,13b,13c,13d into the second set of insertion holes 20a,20b,20c,20d whereby the flexible splits 15a,15b,15c,15d engage with the third set of engagement holes 20a,20b,20c,20d.

The third set of elongated members 10a,10b is mounted between two elongated members from the second set 9a,9b,9c,9d. The third set of elongated members 10a,,10b is in this case shown fixedly mounted to the second set of elongated members 9a,9b,9c,9d from the production line, however it could just as well be mounted by other mounting means such as the releasable means described above.

By mounting the third set of elongated members 10a,,10b across the second set of elongated members 9a,9b,9c,9d, the table is suitable for outdoor use since the legs will not sink into soft ground, such as sand, making it much more stable.

Furthermore the side walls 21a,21b of each frame 4a,4b abut against each other stabilizing the structure such that the table 18 will resist collapse due to pressure exerted on the panel 5a,5b from the side of the panel opposite the frame 4a,4b, making the table 18 even more stable and capable of carrying a considerable load.

FIG. 3 shows a wagon 22 built with the components of the structure 1 shown in FIG. 1 in co-operation with some additional components. The additional components include a handle 23, four wheels 24a,24b,24c,24d (only some of which are visible in the figure) and a piece of cloth 19 thereby.

Instead of a handle 23 as shown in FIG. 3, a bar (not shown) for connecting the wagon to a bicycle could be provided. This transforms the wagon into a bicycle trailer for easy transport in urban areas.

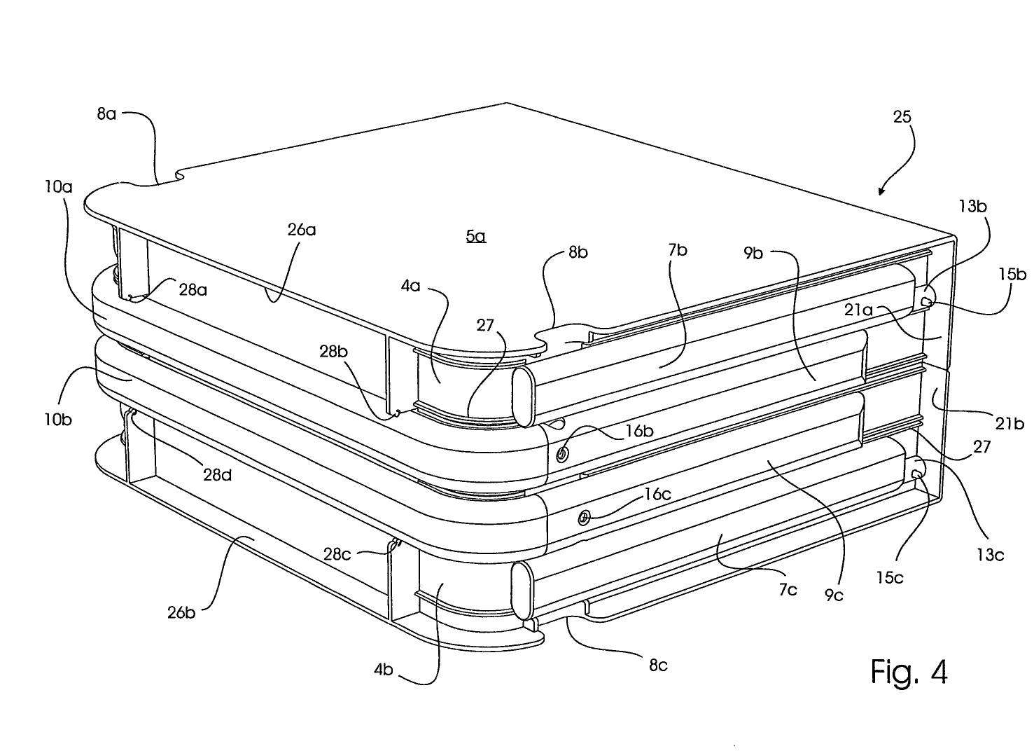

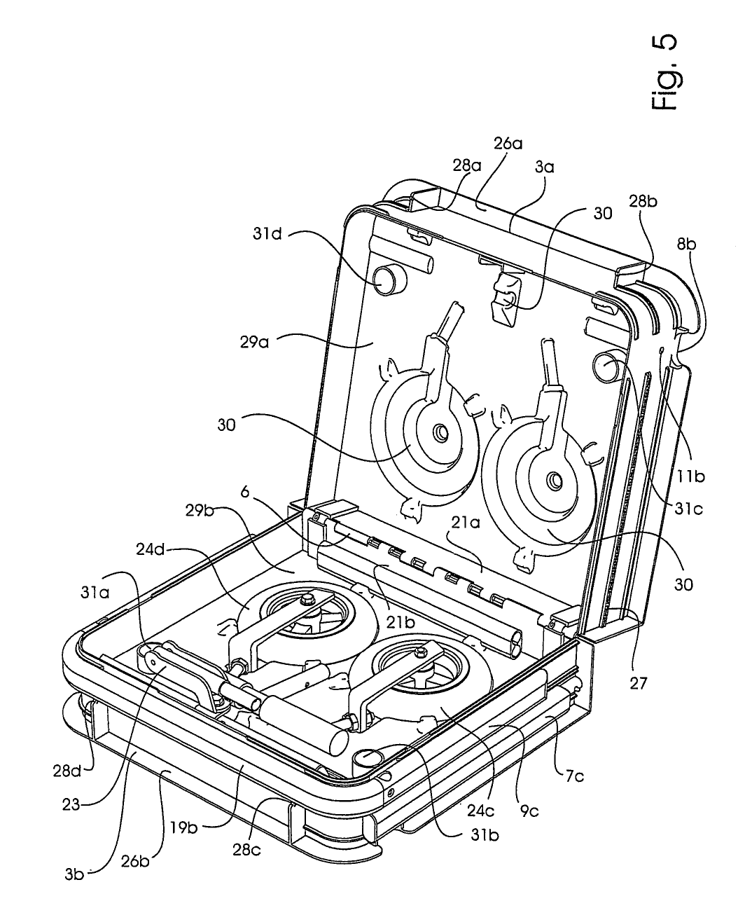

FIGS. 4 and 5 shows the structure 1 in a second mode where it is transformed to a storage structure 25.

As shown in FIG. 4 the two halves 3a, 3b of the base 2 are folded together so that the edges opposite the panels 5a,5b of each frame halves 4a,4b abut against each other.

The panels 5a,5b of the base halves 3a,3b have a periphery extending over the frame 4a,4b in some areas thereby creating a periphery zone 26a,26b. This zone serves to protect the set of elongated members 7a,7b,7c,7d,9a,9b,9c,9d,10a,10b mounted on the outside of the frame 4a,4b from damage.

In order to properly secure the sets of elongated members, ridges 27 are provided on the frames 4a,4b. The ridges extend along the circumference of the frame. A locking mechanism in the shape of a flexible tab 28a,28b,28c,28d snaps the elongated members into place between the ridges 27.

An additional handle (not shown) could be provided for making the storage structure 25 easy to carry.

In FIG. 5 the two base halves 2a,3b have been pivoted around the hinge 6 to an open position. Inside the frames 4a,4b forms 29a,29b have been arranged for safely mounting some of the components in such a way that it is easy to carry the storage structure around without risking that the components tumble around compromising the balance and handling of the storage structure 25.

As it can be seen the forms 29a,29b are provided with mountings 30 for holding components such as the wheels 24a,24b,24c,24d and the handle 23 described above.

The forms provided in each frame 4a,4b can be made of a plastic material and have a shape suitable for keeping the different components of the structure in place in the storage structure 25.

FIG. 5 further shows the wheel mountings 31a,31b,31c,31d wherein the wheels can be mounted in order to generate the wagon shown in FIG. 2.

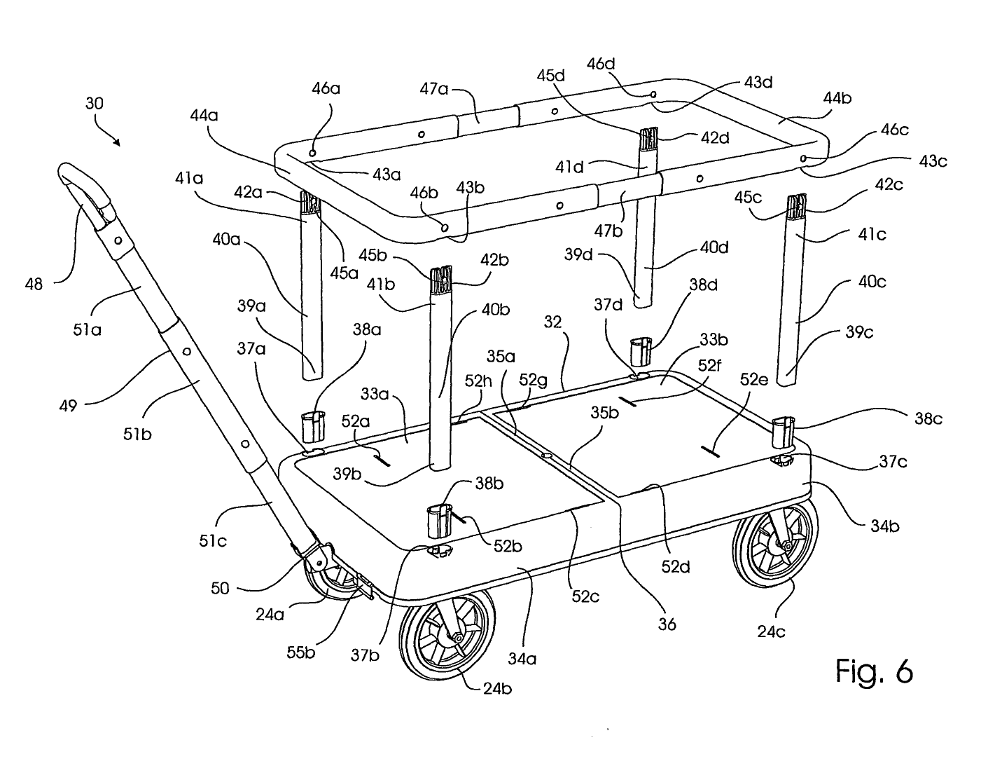

FIG. 6 shows a second embodiment of the structure according to the invention, where the components of the structure, when assembled, form a second wagon 30.

Like the previous embodiment of a wagon, the second embodiment 30 of the structure is comprised of a second base 32 which consists of two second halves 33a,33b. Each second half consists of a second frame 34a,34b bridging a second panel 35a,35b. The two bases are connected together via a second hinge 36.

In each half, two through-going holes 37a,37b,37c,37d are provided which are perpendicular to the second base 32. Each hole is formed to receive a socket 38a,38b,38c,38d and the socket is formed to receive a first end 39a,39b,39c,39d of an elongated member of a fourth set of elongated members 40a,40b,40c,40d.

On the second ends 41a,41b,41c,41d of the elongated members of the fourth set of elongated members there is provided engagement keys 42a,42b,42c,42d for engaging with engagement slots 43a,43b,43c,43d provided on a fifth set of elongated members 44a,44b. Each key is provided with a locking pin 45a,45b,45c,45d, which locks with a corresponding locking hole 46a,46b,46c,46d provided in the engagement slot.

The fifth set of elongated members is mutually connected via a sixth set of elongated members 47a,47b. The sixth set of elongated members engages with the fifth set of elongated members with engagement keys and holes (not shown) as described above.

On the side of the base, opposite the fourth, fifth and sixth set of elongated members, are mounted four wheels 24a,24b,24c,24d, two on each half of the base.

A handle 48, for pulling the wagon, is connected to one of the base halves via a bar 49 and a third hinge 50. The bar consists of a seventh set of elongated members 51a,51b,51c mutually connected to each other with engagement keys and slots (not shown) as described above.

Furthermore, a set of slits 52a,52b,52c,52d,52e,52f is formed on the two halves. These are for mounting a child seat (not shown) according to the ISOFIX standard. Said standard is well known in the automobile industry for safely and quickly mounting a child seat inside a car.

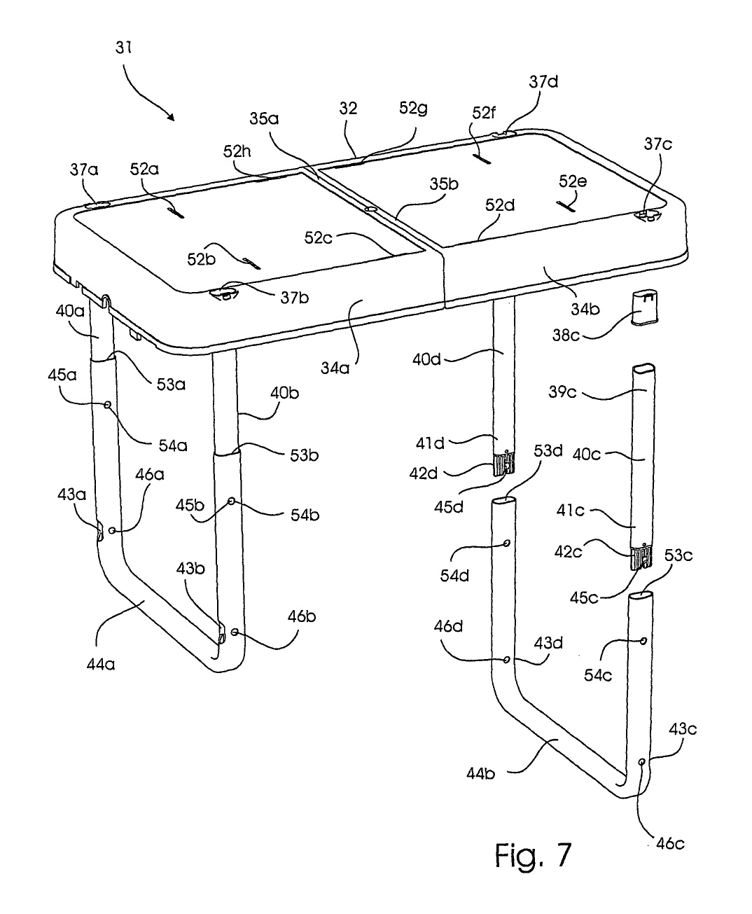

In FIG. 7 the components of the second embodiment of the structure have been assembled into a table 31.

This is realized by mounting the fourth set of elongated members in the sockets, which are then mounted in the through going holes 37a,37b,37c,37d in the base from the opposite side of this than in the structure shown in FIG. 6. The engagement members of the fourth elongated members then engage with engagement slots 53 of the fifth elongated members, where the locking pins of the engagement member of the fourth elongated members locks with locking holes 54 on the fifth elongated members.

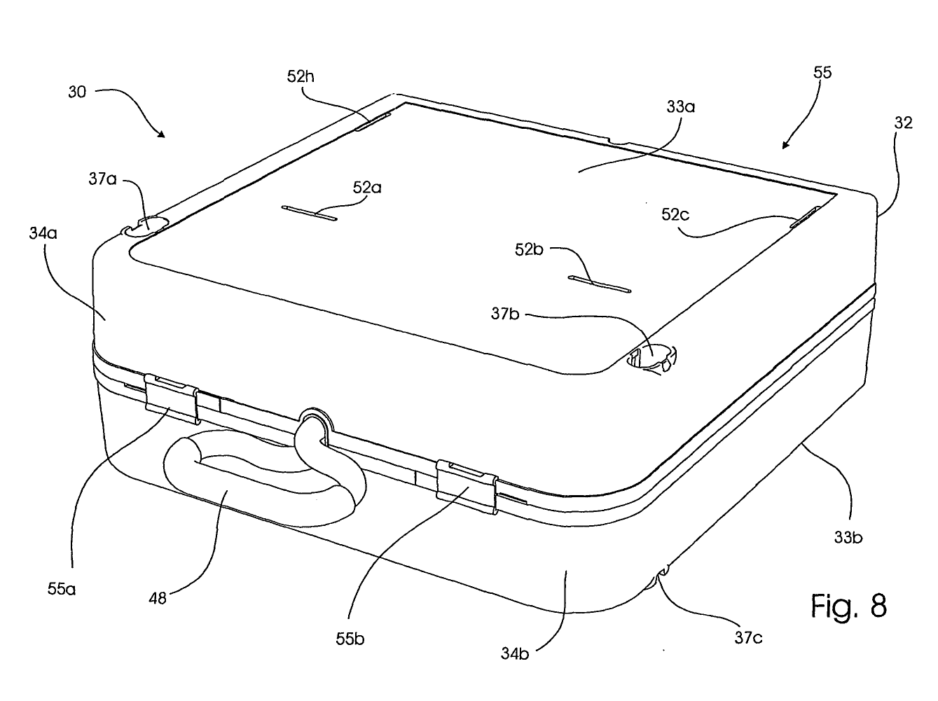

In FIG. 8 the two halves of the base are closed about the second hinge so that the second frames abut each other, thereby forming a second storage structure 55.

Furthermore, the handle is mounted between the two frames, whereby the storage structure is easy to carry around. Locking elements 56 are provided to keep the two halves together when the structure is transported.

It should be noted that all the components of the structure are dimensioned so that they can be stored inside the second storage structure.

It should be understood that the above embodiments are for illustrative purposes since many other embodiment could be provided within the scope of the invention.

Within the scope of the present invention the components of the structure can be produced of a wide range of appropriate materials such as plastics, metal, or wood, to mention just a few possibilities.

Furthermore the different mounting means described are not limiting to the invention as any mounting mean applicable to the present invention and known to the person skilled in the art can be used.

What is claimed is:

1. A transformable structure having a number of components adapted for in a first mode to be assembled in such a way that any one of at least two different supporting structures can be formed and in a second mode to be assembled in such a way that a storage structure, wherein the structure can be stored, can be formed, comprising
a base consisting of two halves each comprising a panel bridging a frame, whereby the two base halves are connectable with each other in at least a first position where the panels are mainly flush and in at least a second position where the free edges of the frames are adjacent to each other, and
at least two sets of elongated members adapted for in the first mode being assembled with the base in its first position and in the second mode being assembled with the base in its second position.

2. The transformable structure according to claim 1, wherein the two base halves are pivotally connected to each other about a hinge between the first position and the second position and where the hinge is mounted on a side wall of each frame.

3. The transformable structure according to claim 1, wherein the first set of elongated members are mainly perpendicular mounted to the base, and the second set of elongated members are adapted for crosswise connection with the first set of elongated member.

4. The transformable structure according to claim 1, wherein the first set of elongated members are mainly perpendicular mounted to the base, and the second set of elongated members are adapted for connection in extension with the first set of elongated member.

5. The transformable structure according to claim 1, comprising a set of third elongated members adapted for connection with the first or second sets of elongated members

6. The transformable structure according to claim 5, wherein the third elongated members are adapted for connection with the first set of elongated members.

7. The transformable structure according to claim 5, wherein the third elongated members are adapted for connection to the second set of elongated members.

8. The transformable structure according to claim 1, wherein a peripheral edge zone of the panel extends beyond the periphery of the frame.

9. The transformable structure according to claim 1, wherein the sets of elongated members are mounted on the outside of the frame and that incisions for accommodating the sets of elongated members are shaped in the panel.

10. The transformable structure according to claim 1, further comprising a number of components forming at least two wheels adapted for mounting on the base on the same side of the panel as the frame.

11. The transformable structure according to claim 1 further comprising a number of components forming a handle adapted for mounting on at least one of the two base halves.

12. The transformable structure according to claim 1 wherein a piece of cloth is extended between the sets of elongated members.

13. The transformable structure according to claim 1 wherein there on the inside of the frame is provided a form molded to fit at least one of the components.
